(19) United States
(12) Patent Application Publication
(10) Pub. No.: US 2002/0141100 A1
(43) Pub. Date: Oct. 3, 2002

(54) Method and system for shock assisted recording head protection

(76) Inventors: Jeffrey M. Garrigues, Perry, UT (US); George H. Smedley JR., South Ogden, UT (US)

Correspondence Address: DINSMORE & SHOHL, LLP, 1900 CHEMED CENTER, 255 EAST FIFTH STREET, CINCINNATI, OH, 45202, US

(21) Appl. No.: 09/818,983

(22) Filed: Mar. 27, 2001

(51) Int. Cl. G11B 21/02

(52) U.S. Cl. 360/75; 360/256.3

(57) ABSTRACT

A data storage device comprising a carriage configured to hold a recording head and a locking system. The carriage is movable in a protected direction toward a protected position and in an unprotected direction away from the protected position. The locking system includes a locking member which is movable from a fully engaged position in which the carriage is restrained from movement in the unprotected direction, to a disengaged position in which the carriage is free to move in the unprotected direction to read and/or write data to a recording medium. The locking system is configured to move the locking member toward the fully engaged position in response to a force having a component in the unprotected direction. In one exemplary embodiment, the locking system comprises a linkage rotatably connecting the locking member with a movable member that comprises a solenoid.

### TECHNICAL FIELD

The present invention relates generally to the protection of recording heads, and more particularly, to a method and system for shock assisted recording head protection

### BACKGROUND OF THE INVENTION

Currently, a number of data storage devices exist for the storage of digital data on recording media. For example, magnetic storage devices can be utilized for the storage and/or retrieval of digital data on magnetic recording media, optical storage devices can be utilized for the storage and/or retrieval of digital data on optical recording media, and semiconductor storage devices can be utilized for storage and/or retrieval of digital data on semiconductor recording media. In such devices, the recording media can be permanently mounted or removable. Examples of magnetic data storage systems which accept removable magnetic disk cartridges include the ZIP® drive device, manufactured and marketed by the Iomega Corporation.

In many data storage devices, heads are provided to control the reading and writing of the data to the media. Such heads can be very sensitive to shock forces and generally should be protected when not in use, such as during transportation or when the recording media is not present. Accordingly, systems can be provided which retract the head to a safe or protected position during such times. A variety of locking systems can then be utilized to minimize unintended movement of the heads and potential damage to the heads. such times. A variety of locking systems can then be utilized to minimize unintended movement of the heads and potential damage to the heads.

For example, in a magnetic disk drive device, when a removable magnetic disk is placed in the drive, read/write heads are then permitted to move away from their protected position and toward the read/write position which allows the heads to read and write data to the disk. When the disk is removed, the heads are then retracted to a protected position. A latch can then engage the head carriage to prevent movement of the heads toward the unprotected read/write position.

However, if the drive device is subject to a shock force while the heads are in the protected position, the latch can become disengaged and the heads will then be free to move to the unprotected position. In such a situation, the heads will be at risk to damage and malfunction.

Accordingly, there remains a need for a recording head protection system which is less prone to inadvertent disengagement in the presence of shock forces and which better protects the recording heads from damage and/or malfunction.

### SUMMARY OF THE INVENTION

It is an object of at least one embodiment of the present invention to provide an improved recording head protection system.

A further object of at least one embodiment of the present invention is to provide a recording head protection system which is less prone to inadvertent disengagement in the presence of shock forces.

A still further object of at least one embodiment of the present invention is to provide a recording head protection system which provides increased head protection in the presence of shock forces.

Additional objects, advantages, and novel features of various embodiments of the invention will be set forth in part in the description of the exemplary embodiments that follows, and in part will become apparent to those skilled in the art upon examining or practicing the invention.

One embodiment of the present invention is directed toward a data storage device comprising a carriage configured to hold a recording head and a locking system. The carriage is movable in a protected direction toward a protected position and in an unprotected direction away from the protected position. The locking system includes a locking member which is movable from a fully engaged position in which the carriage is restrained from movement in the unprotected direction, to a disengaged position in which the carriage is free to move in the unprotected direction to read and/or write data to a recording medium. The locking system is configured to move the locking member toward the fully engaged position in response to a force having a component in the unprotected direction. In one exemplary embodiment, the locking system comprises a linkage rotatably connecting the locking member with a movable member that comprises a solenoid.

According to another aspect of the invention, a method for protecting a data storage head is provided. The method comprises providing a carriage for a data storage head, wherein the carriage is movable in an unprotected direction in order to read a recording medium. The method further comprises engaging a locking member with the carriage to resist the movement of the carriage in the unprotected direction, and, in response to a shock force in the unprotected direction, further engaging the locking member with the carriage.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which like reference numerals indicate corresponding structure throughout the figures.

FIG. 1 is a perspective view of an exemplary digital data storage device, which can include a recording head locking system made in accordance with principles of the present invention;

FIG. 2 is a perspective view of an exemplary disk cartridge which can be utilized with the exemplary storage device of FIG. 1;

FIG. 3 is a schematic view of the storage device of FIG. 1, illustrating the various systems thereof, including an exemplary recording head locking system made in accordance with principles of the present invention and shown in the engaged position;

FIG. 4 is a schematic view of the storage device of FIG. 3, illustrating the exemplary recording head locking system moved in an engagement direction toward a further engaged position, in response to a shock force having a component in the unprotected direction;

FIG. 5 is a schematic view of the storage device of FIG. 3, illustrating the exemplary recording head locking system moved in a disengagement direction to a disengaged position;

FIG. 6 is a schematic view of an alternative data storage device, illustrating an exemplary recording head locking system having a locking member which is moved into further locking engagement when a force having a component in the head unprotect direction is received, in accordance with principles of the present invention;

FIG. 7 is an enlarged view of the solenoid shown in FIGS. 3-5;

FIG. 8 is a schematic view of the exemplary storage device of FIG. 3, illustrating the exemplary recording head locking system moved in a disengagement direction in response to shock forces having a component in the protect direction; and

FIG. 9 is a schematic view of an exemplary data storage device having an alternative shock resistant head retention system made in accordance with principles of the present invention.

### DETAILED DESCRIPTION OF EXEMPLARY EMBODIMENTS

In general, the present invention relates to data storage devices having recording heads which are restrained from movement by an improved head locking system. The head locking system includes a locking member which, in response to shock forces in the head unprotect direction, further engages the head carriage to provide additional protection from movement of the heads.

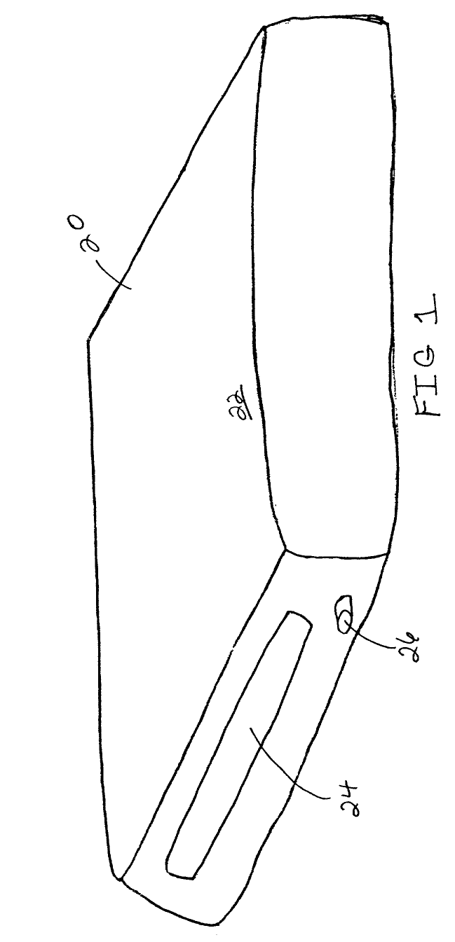

FIG. 1 is a perspective view of an exemplary data storage device 20. In this example, the data storage device 20 comprises a disk drive comprising an outer housing 22 which includes an opening 24 configured to receive a disk cartridge. An eject button 26 is also provided as part of the device 20 for automatically ejecting a disk cartridge from the device. The disk drive 20 can be used as a standalone external drive or as an internal drive within a computer or other digital device. While the present invention has application to storage devices which receive removable cartridges, such as the exemplary device shown in FIG. 1, it will be understood that the invention can be applicable to a variety of other data storage devices as well.

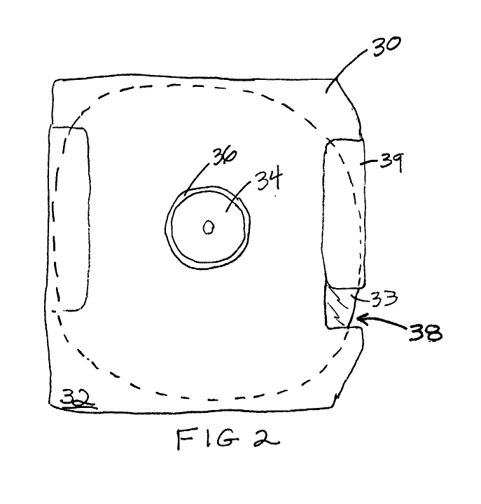

FIG. 2 illustrates an exemplary disk cartridge 30 which is configured for use with the disk drive device 20 of FIG. 1. The cartridge 30 includes an outer casing 32 and a disk-shaped recording medium 33 is rotatably mounted in the casing via a hub 34 which is accessible through an opening 36 in the casing. A head access opening 38 on the front edge of the disk cartridge 30 provides access to the recording surfaces of the disk 30 by the recording heads of the disk drive device 20. A shutter 39 is provided to cover the head access opening 38 when the disk cartridge 30 is not in use. When the cartridge is inserted into the disk drive 30, the shutter 39 moves to the side exposing the head access opening 38 and thereby providing access by the recording heads of the disk drive 20 to the recording medium 33. In the present example, the casing 32 houses a flexible magnetic recording disk 33, although the recording medium could comprise other suitable recording medium, such as magnetic, optical, or magneto-optical media.

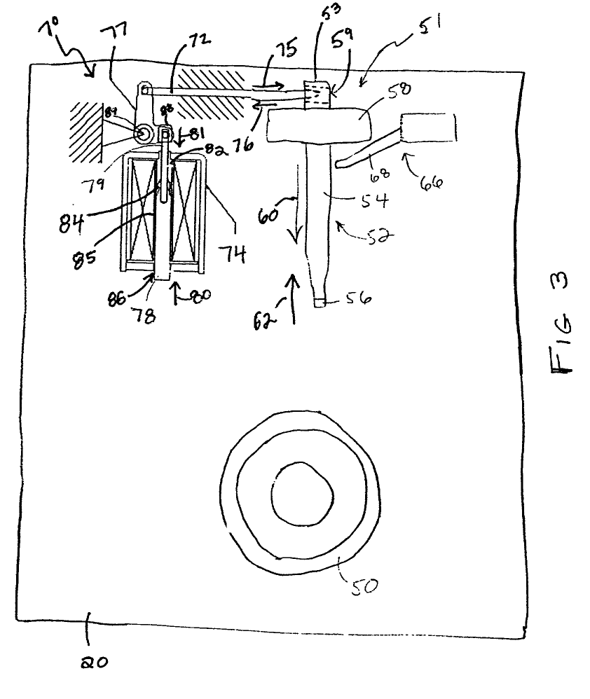

FIGS. 3-5 are schematic views of the exemplary disk drive system 20 of FIG. 1, illustrating various systems and components which may be included in such a drive. In particular, a spindle motor 50 can be provided to rotate the recording medium of a disk cartridge at a predetermined operating speed. In addition, a linear actuator 51 can be provided and can include a carriage 52. The carriage can include one or more arms 54, or other suitable supporting members, for supporting one or more recording heads 56 which are configured to read data from and/or write data to the recordable medium. Also provided as part of the linear actuator 51 is a coil 58, such as a voice coil for example. If it is desirable to read data from both sides of a recording medium, a pair of heads 56 can be provided and carried by a pair of arms 54.

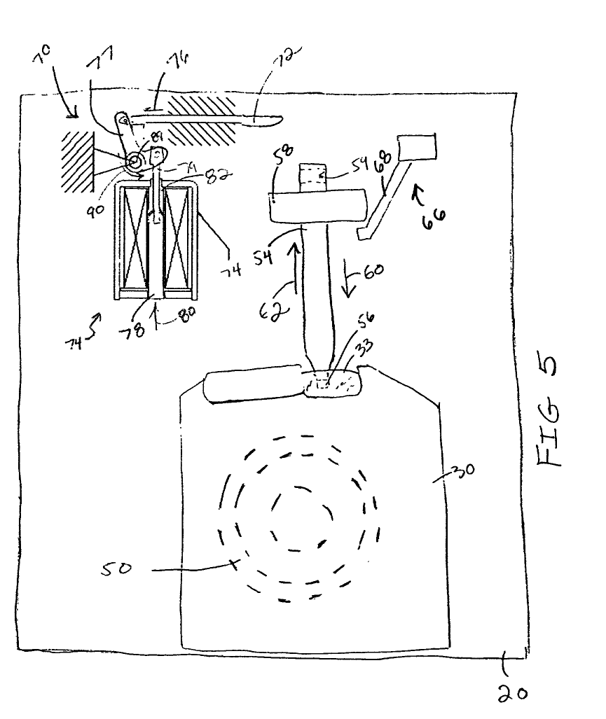

The linear actuator 51 is movable in at least two directions, as shown by comparing FIG. 3 with FIG. 5. In particular, the linear actuator 51 is movable in an unprotected direction 60 from the protected position shown in FIG. 3 toward the unprotected position shown in FIG. 5. In the protected position shown in FIG. 3, the heads 56 are relatively protected from damage and are withdrawn from the motor 50 which supports the recording medium. As the heads 56 move in the unprotected direction 60 toward the unprotected position shown in FIG. 5, the heads 56 are more susceptible to damage, but are moved toward a position which allows them to read and/or write data to the recording medium 33 supported by the motor 50 (or by any other device suitable for supporting the medium). After the reading and/or writing of data is complete and/or when it is desirable to protect the heads, the heads 56 can then be moved in a protected direction from the unprotected position of FIG. 5 toward the protected position of FIG. 3.

The movement of the linear actuator 51 in the unprotected direction 60 can be accomplished in any suitable manner. For example, in the exemplary embodiment illustrated, the coil 58 can interact with magnets (not shown) to move the carriage 52 linearly so that the heads 56 can move radially over the recording medium 33 of the disk cartridge 30 inserted into the disk drive 20. However, other suitable devices and methods for movement of the carriage 52 can be utilized, such as motors, solenoids, servo-motors, or other electrical and/or mechanical actuators.

As also shown in FIGS. 3-5, to move the linear actuator 51 in the protected direction 62, a head retraction system 66 can be utilized which includes a head retraction arm 68. The arm 68 can drive the actuator 51 back to the protected position of FIG. 3, whenever needed or desired. For example whenever the disk cartridge 30 is intentionally or unintentionally removed from its disk access position, the arm 68 can drive the actuator 51 back to the protected position of FIG. 3, to avoid damage to the heads 56. The retraction system 66 can include springs, motors, gears, and/or other electrical and/or mechanical devices suitable for moving the actuator 51 to a protected position (i.e., parked or retained position). In addition to retracting the actuator 51, the system 66 can also be useful for assisting in movement of the carriage 52 in the unprotect direction 60 for loading the heads 56 onto the medium. Exemplary devices for head retraction, disk recording, and disk ejection are disclosed in U.S. Pat. No. 5,943,193, U.S. Pat. No. 6,072,666, U.S. Pat. No. 6,147,842, and U.S. Pat. No. 5,943,185, and in the U.S. patent application entitled Method and System for Head Retraction in a Data Storage Device, (Garrigues et al.) Attorney Docket No. 26099-2, the entire disclosures of which are hereby incorporated herein by reference.

To retain the carriage 52 in the parked position, a locking system 70 is provided which includes a locking member 72. The locking member 32 is configured to selectively engage the carriage 52 to retain the carriage in the protected position. In this exemplary embodiment, the locking member 72 comprises a latch which engages a latch receptacle 59 formed near the rearward end 53 of the carriage 52, to thereby retain the carriage 52 in the protected position. However, any electrical and/or mechanical locking member suitable for retaining the carriage in the protected position can be utilized, as can any suitable engagement configuration between the locking member and the carriage.

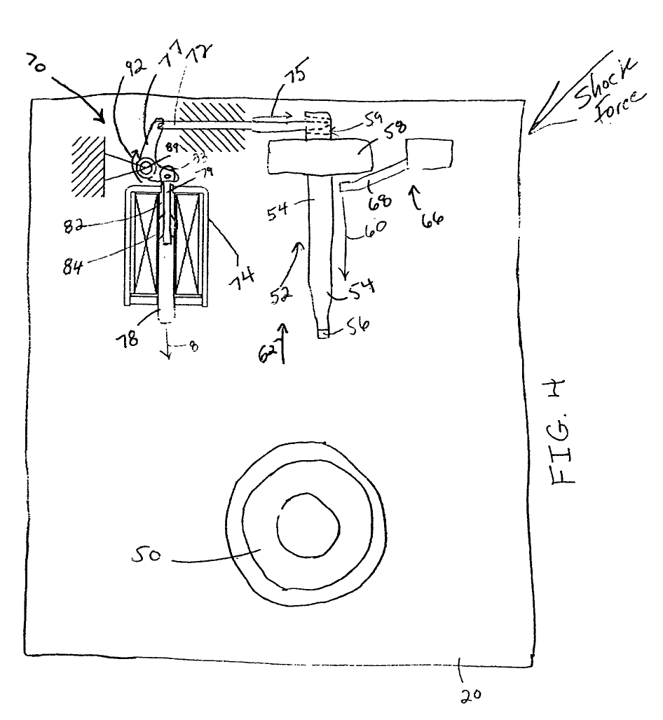

Also provided in the exemplary locking system 70 of FIGS. 3-5 is a movable member 74 which acts on the locking member 72 to move the locking member 72 in an engagement direction 75 toward a fully engaged position in which a longer length of the locking member has entered the receptacle 59 (e.g., the position shown in FIG. 4). The movable member 74 also acts on the locking member 72 to move the locking member 72 in a disengagement direction 76 toward a disengaged position in which no length of the locking member enters the receptacle 59 (e.g., the position shown in FIG. 5). A linkage 77 can be provided to allow the movable member 74 to act on the locking member 72 for moving the locking member in the engagement direction 75 and the disengagement direction 76.

In this exemplary embodiment, the linkage 77 comprises a rocker linkage, and the movable member 74 comprises a solenoid having a plunger member 78 connected to a pin 79. The pin 79 is rotatably connected to the rocker linkage 77, which is in turn rotatably connected to the locking member 72. For example, pins or hinges can be utilized to connect the linkage 77 with the solenoid pin 79 and with the locking member 72. Accordingly, the linkage 77 and the locking member 72 are relatively rotatably movable, and the linkage 77 and solenoid pin 79 are relatively rotatably movable. The linkage 77 is also free to rotate in the clockwise and counter-clockwise direction about a fixed pivot point 89, such as via a pin or hinge.

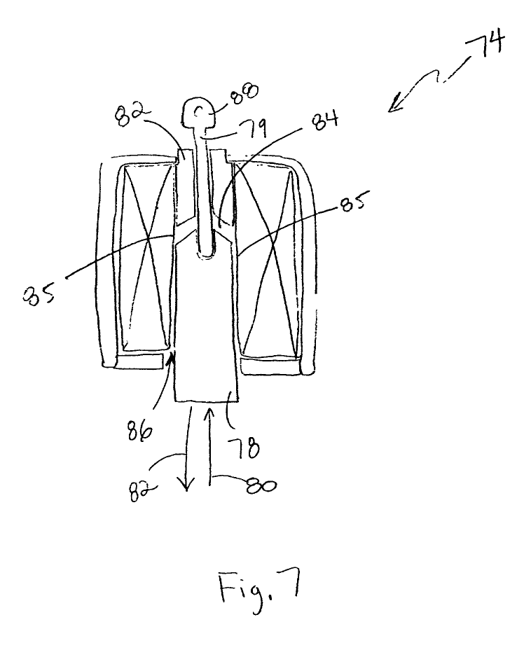

A stop 82 is provided in the solenoid 74 and, when the solenoid is in its de-energized position of FIG. 3, a gap 84 exists between the plunger 78 and the stop 82. As best shown in FIGS. 3 and 7 (an enlarged schematic view of the solenoid), the stop 82 remains stationary in the central chamber 86 of the solenoid 74, such as by adhesion or connection to the chamber walls 85. However, the plunger 78 and attached pin 79 are free to move linearly within the central chamber 86, and do not adhere or fixedly connect to the chamber walls 85. Accordingly, the plunger 78 and attached pin 79 are free to slidingly move within the chamber 86, while the stop 82 is not. Movement of the plunger 78 and attached pin 79 in the push direction (i.e., locking direction) 80 is limited by the abutment of the plunger 78 with the stop 82. Conversely, movement of the plunger 78 and attached pin 79 in the pull direction 81 is limited by the abutment of the pinhead 88 with the stop 82.

Turning now again to FIGS. 3-5, this exemplary arrangement allows the solenoid 74 to act on the locking member 72 via the linkage 77. In particular, movement of the plunger 78 and attached pin 79 in the push direction 80 causes corresponding counter-clockwise rotation 90 of the linkage 77 resulting in movement of the locking member 72 in the disengagement direction 76, as best shown in FIG. 5. However, movement of the plunger 78 and attached pin 79 in the pull direction 81 causes corresponding clockwise rotation 92 of the linkage 77 resulting in movement of the locking member 72 in the engagement direction 75, as best shown in FIG. 4.

In this exemplary embodiment, the solenoid 74 controls the movement of the plunger 78 and the attached pin 79 in the push direction 80 by electromagnetic force. In particular, when it is desirable to allow the control heads 56 to be free to move from the protected position of FIG. 3, a control signal can be provided to the solenoid 74, as known in the solenoid art. This signal causes the plunger 78 and attached pin 79 to move in the push direction 80. As shown in FIG. 5, due to the rotatable engagement of the linkage 77 and the pinhead 88, this movement results in rotation of the linkage 77 about the pivot point 89 in the counter clockwise direction 90, and can continue until the plunger 78 comes into contact with the stop 82. Due to the rotatable engagement of the linkage 77 and the locking member 72, the resulting rotation of the linkage 77 in the counter clockwise direction 90 causes movement of the locking member 72 in the disengaged direction 76. Accordingly, the locking member 72 no longer engages the receptacle 59 and the carriage 52 is free to move in the unprotect direction 60 to position the heads 56 to read the recording medium 33.

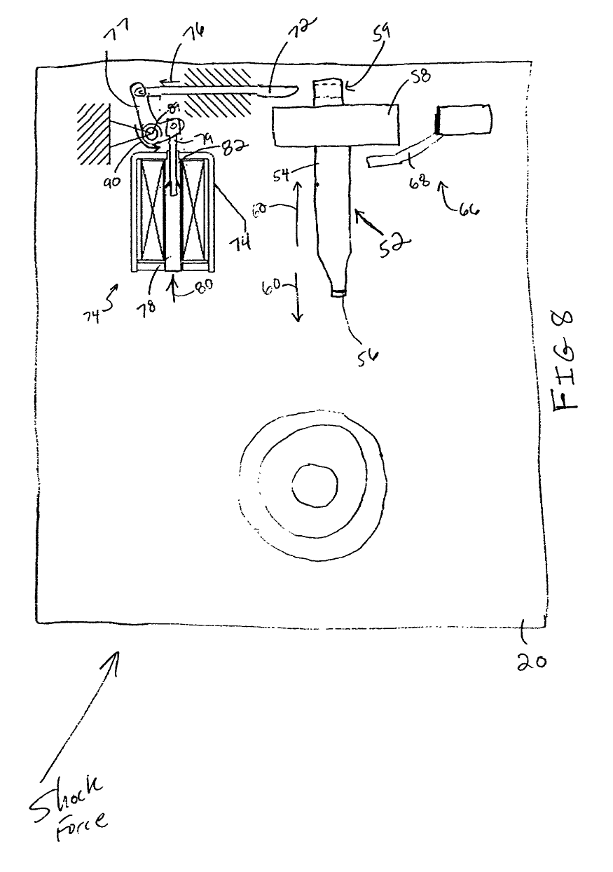

Another instance which may cause such movements of the pin 79, linkage 77, and locking member 76 is shown in FIG. 8. In particular, FIG. 8 shows how such movements can occur in response to a shock force acting on the device 20. When the locking member 72 is in an engaged position where the carriage 52 is restrained from movement in the unprotected direction 60, a shock force having a component in the protected direction 62 will cause movement of the pin 79 in the push direction 80, rotation of the linkage 77 in the counter-clockwise direction 90, and movement of the locking member 72 in the disengagement direction 76. However, although the locking member 72 may become disengaged from the carriage 52 with such a movement, the carriage will not move in the unprotected direction 60. More specifically, this shock force will simply cause further movement of the carriage 52 in the protected direction 62 (if any movement at all), and such a movement generally does not pose danger to the heads 56.

On the other hand, a shock force having a component in the unprotect direction 60 could create a force on the carriage 52 in the unprotect direction 60, creating a risk of damage to the heads 56, if the carriage 52 is not secured in the protected position (of FIGS. 3 and 4). However, this exemplary arrangement of FIGS. 3-5 can further lock the carriage 52 in response to such shock forces. In particular, as shown in FIG. 4, when a shock force is received having a component in the unprotect direction 60, that shock force can cause movement of the solenoid plunger 78 and attached pin 79 in the pull direction 82. This movement further widens the gap 84 between the plunger 78 and the stop 82. The movement can continue until the pin head 88 reaches the stop 82. Movement of the pin 79 in this pull direction 82 causes corresponding clockwise movement 92 of the linkage 77, which is rotatably connected to the pin 79. The clockwise movement 92 of the linkage 77 causes a corresponding movement of the locking member 72 in the engagement direction 75, thereby pushing the locking member further into the lock receptacle 59 of the carriage 52 and toward a more fully engaged position. Accordingly, shock forces having components in the unprotect direction 60 actually assist the engagement of the locking system 70 with the arm 54 of the carriage 52, thereby providing added assurance that the carriage 52 will not move in the unprotect direction 60 and further minimizing the risk of damage to the heads 56. While movement of the carriage 52 in the unprotect direction 60 is to be avoided when the assembly is in the protected position of FIGS. 3 and 4, shock forces which attempt to move the carriage in the unprotect direction actually further lock or engage the carriage in the protected position, according to principles of the present invention.

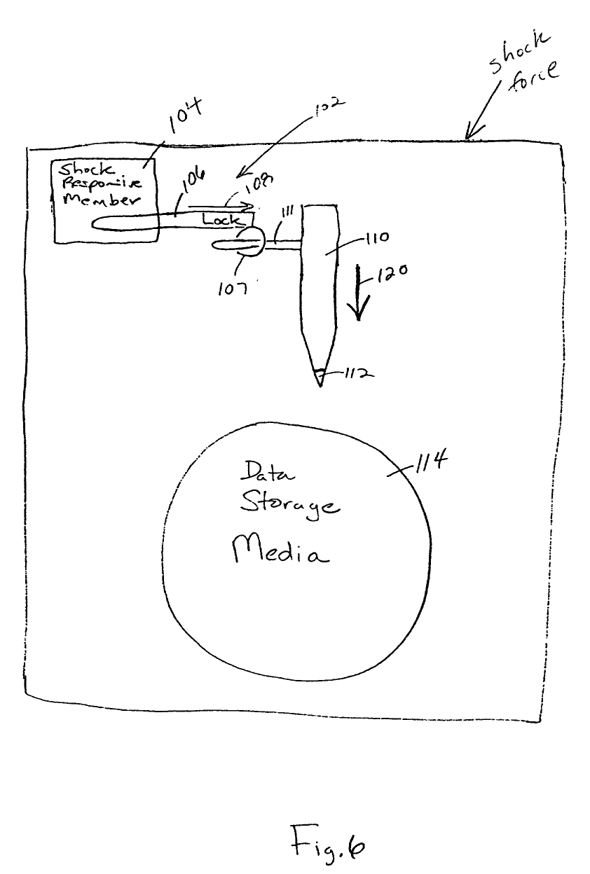

Although FIGS. 3-5 and 7-8 illustrate various potential configurations of carriages, movable members, linkages, and locking members, other configurations and/or devices can be utilized. FIG. 6 illustrates another exemplary embodiment of a data storage device 100 having a shock assisted head locking system 102. In this system, a shock responsive movable member 104 is provided which acts on a locking member 106. The locking member 106 has a locking interface portion 107 which moves relative to a corresponding locking interface portion 111 on the head carriage 110. The carriage 110 supports at least one head 112 for reading data from a data storage media 114. The member 104 reacts to shock forces having components in the unprotect direction 120 and, in response thereto, then provides a force on the locking member 106 in the engagement direction 108. This moves the interface portions 107 and 111 into further locking engagement. The shock response member 104 can comprise electrical, mechanical, and/or electromechanical devices which can move in response to shock forces having a component in the unprotect direction 120. The movement is translated into corresponding movement of the locking member 106 in the direction 108 using any suitable linking components and/or methods. Accordingly, shock forces having a component in the unprotect direction 120 will cause further engagement of the portions 107 and 111, thereby strengthening the locking action and providing less risk that the locking system 102 and the carriage 110 will disconnect. The carriage 110 can comprise any suitable head supporting member (e.g., arm, beam, seat, support, etc.), the locking member 106 can comprise any suitable mechanical and/or electrical device for restraining the carriage (e.g., latch, mechanical lock, shackle, electrical lock, etc.), and the movable member 104 can comprise any suitable mechanical and/or electrical device which can provide movement in response to shock forces having a component in the unprotected direction (e.g., movable mass, actuator, solenoid, etc.). If desired, a linkage (e.g., a gear, fastener, joint, pin, or mechanical link, etc.) can be utilized to interconnect the movable member and the locking member.

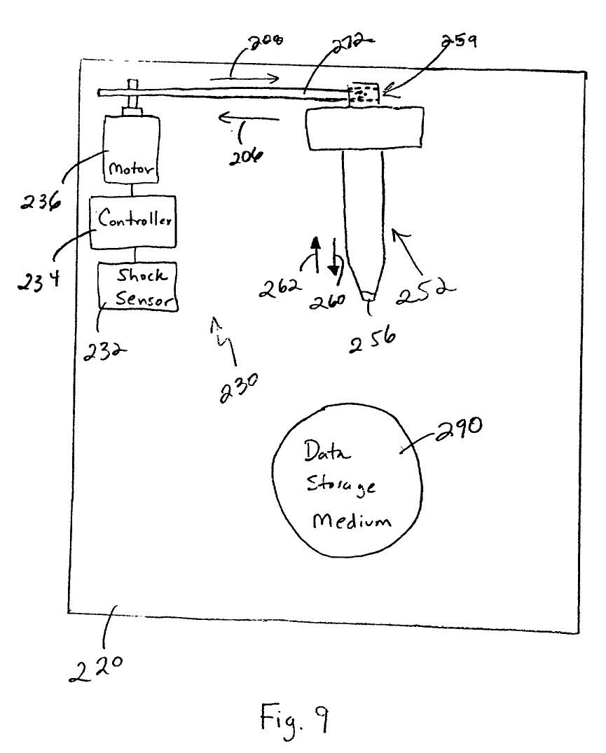

FIG. 9 is a schematic view of an exemplary data storage device 220 having an alternative exemplary shock resistant head locking system 230, made in accordance with principles of the present invention. In this embodiment, the head locking system 230 comprises a locking member 272, a motor 236, a controller 234, and a shock sensor 232. The system 230 selectively engages the locking member 272 with a corresponding receptacle 259 connected to a head carriage system 252. The head carriage system 252 is selectively movable in an unprotect (e.g., head loading) direction 262 to allow the heads 256 carried by the carriage 252 to read from and/or write to a data storage medium 290. In addition, the carriage 252 is movable in a head unprotect direction 262 for protecting the recording heads 256 when desired. The locking member 272 can be driven by a motor 236 in an engagement direction 208 to engage the receptacle 259 when it is desired to protect the heads 256, and in a disengagement direction 206 to allow the carriage 252 to freely move, such as when it is desired to read from and/or write to a data storage medium 290. A head retraction mechanism, such as the mechanisms described above for example, may also be utilized if desired to assist in moving the heads in the unprotect direction 260 and/or protect direction 262.

The exemplary system 230 includes a shock sensor 232 which can indicate the presence of shocks to the data storage device 220. The shock sensor 232 could comprise any suitable sensor for detecting the presence of shock forces of a given magnitude, such as a piezoelectric shock sensor for example. Upon detection of a shock force, the shock sensor 232 provides a detection signal to a controller circuit 234, which could comprise a processor or other suitable control circuit. The controller 234 then provides a control signal to the motor 236 which then causes movement of the locking member 272 in the engagement direction 208 to cause further engagement of the locking member 272 and the carriage 252. The motor, which can comprise any suitable motor or actuator, such a rotary or linear motor for example, can be coupled to the locking member 272 using any suitable linkage or coupling. For example, in the case of a rotary motor, a ball screw or roller screw could be utilized. When it is desired to unlatch the locking member 272 from the receptacle 259, the controller 234 can provide a control signal to the motor 236 to cause the locking member 272 to move in the disengagement direction 206 until the locking member 272 is free from the receptacle 259 and the carriage 252 is free to move in the unprotect direction 260, to read from and/or write to the medium 290. The controller 234 can be integral with the main control circuitry of the device 220, or it can be provided as separate unit. When the carriage 252 is retracted to protect the recording heads 256, the controller moves the motor 236 into engagement with the receptacle 259. When the carriage is in this position and shock forces are detected, the controller 234 will move the locking member 272 an additional amount in the engagement direction 208, to further ensure that the carriage 252 will not move excessively in the unprotect direction 260 in response to these shock forces, and to thereby further protect the recording heads 256. In one exemplary embodiment, the shock sensor 232 detects only shock forces having a component in the unprotect direction 260, and the detection of such forces then causes the controller 234 to move the locking member 272 in the engagement direction 208 by appropriate movement of the motor 236.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. Moreover, although a variety of exemplary configurations and components have been described, it should be understood that a number of other configurations and components could be utilized without departing from the scope of the invention.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

What is claimed is:

1. A data storage device, comprising
a carriage configured to hold a disk drive head, wherein the carriage is movable in a protected direction toward a protected position in which the head is restrained from reading a memory cartridge, and wherein the carriage is movable in an unprotected direction toward an unprotected position in which the head is permitted to read a memory cartridge;
a latch configured to selectively engage the carriage to retain the carriage in the protected position, wherein the latch is movable in an engagement direction to engage the carriage and a disengagement direction to disengage the carriage; and
a movable member configured to move the latch in the engagement direction in response to a force having a component in the unprotected direction.

2. The device as recited in claim 1, wherein the movable member comprises a solenoid.

3. The device as recited in claim 2, wherein the movable member comprises a push-type solenoid having a pin and attached plunger.

4. The device as recited in claim 1, further comprising a linkage connecting the latch and movable member.

5. The device as recited in claim 4, wherein the linkage is rotatably connected to the latch and to the movable member.

6. The device as recited in claim 1, further comprising a head retraction system configured to move the carriage in the protected direction toward the protected position.

7. The device as recited in claim 1, further comprising an electromagnetic actuator adapted to move the carriage in the unprotected direction.

8. The device as recited in claim 1, wherein the movable member comprises a motor, and wherein the data storage device further comprises:
a shock sensor configured to detect shock forces to the device; and
a controller adapted to cause movement of the motor in response to a signal from the shock sensor.

9. A data storage device, comprising:
a carriage configured to hold a recording head, wherein the carriage is movable in a protected direction toward a protected position and in an unprotected direction away from the protected position; and
a locking system having a locking member movable from a fully engaged position in which the carriage is restrained from movement in the unprotected direction, to a disengaged position in which the carriage is free to move in the unprotected direction, wherein the locking system is configured to move the locking member toward the fully engaged position in response to a force having a component in the unprotected direction.

10. The device as recited in claim 9, wherein the locking system further comprises a movable member configured to move the locking member.

11. The device as recited in claim 10, wherein the movable member comprises a solenoid.

12. The device as recited in claim 10, wherein the locking system further comprises a linkage rotatably connecting the locking member and movable member.

13. The device as recited in claim 9, further comprising a head retraction system configured to move the carriage in the protected direction toward the protected position.

14. The device as recited in claim 9, further comprising an actuator adapted to move the carriage in the unprotected direction.

15. The device as recited in claim 9, wherein the locking system comprises a motor.

16. A method for protecting a data storage head, comprising:
providing a carriage for a data storage head, wherein the carriage is movable in an unprotected direction in order to read a recording medium;
engaging a locking member with the carriage to resist the movement of the carriage in the unprotected direction; and
in response to a shock force in the unprotected direction, further engaging the locking member with the carriage.

17. The method as recited in claim 16, further comprises:
in response to a control signal, disengaging the locking member with the carriage.

18. A data storage device, comprising
a recording head system having a head adapted to record to a recording medium, wherein the recording head system is movable in a protected direction and in an unprotected direction;
a locking member configured to selectively engage the recording head system to restrain the recording head system from movement in the unprotected direction, wherein the locking member is movable in an engagement direction to engage the recording head system and a disengagement direction to disengage the recording head system;
a movable member, wherein the movable member is movable in a locking direction in response to a force causing movement of the recording head system in the unprotected direction; and
a linkage connecting the locking member and the movable member and configured to impart movement of the lock in the engagement direction in response to movement of the movable member in the locking direction.

19. The device as recited in claim 18, wherein the locking member comprises a latch and the movable member comprises a solenoid.

20. The device as recited in claim 18, wherein the linkage is rotatably connected to the locking member and the movable member.

21. The device as recited in claim 18, wherein the movable member comprises a motor.

22. The device as recited in claim 18, wherein the movable member comprises a solenoid, the locking member comprises a latch, and the linkage is rotatably connected to both the solenoid and the latch, and wherein the device further comprises:
a control circuit configured to selectively provide a signal to the solenoid to cause movement of the solenoid in an unlocking direction and to thereby cause movement of the locking member in the disengagement direction to disengage the locking member from the recording head system and to allow the recording head system to move in the unprotected direction toward a data storage medium.
